(19) United States
(12) Patent Application Publication
(10) Pub. No.: US 2025/0078072 A1
(43) Pub. Date: Mar. 6, 2025

(54) SYSTEMS AND METHODS FOR USE IN AUTHENTICATION, BASED ON NETWORK DETAILS

(71) Applicant: MASTERCARD INTERNATIONAL INCORPORATED, Purchase, NY (US)

(72) Inventors: David Ver Eecke, Tampa, FL (US); Dennis A. Gamiello, North Salem, NY (US); Brian Piel, Ballwin, MO (US); Warda Zahid Khan, Yorktown Heights, NY (US); Ranjita Shankar Iyer, Chappaqua, NY (US); Nili Klenoff, White Plains, NY (US); Kevin Maxham, Fairfield, CT (US); Julia Sharon Gosset, Tarrytown, NY (US); Valerie Matusiak, Weehawken, NJ (US)

(21) Appl. No.: 18/239,092

(22) Filed: Aug. 28, 2023

(51) Int. Cl. G06Q 20/40

(52) U.S. Cl. CPC G06Q 20/401

(57) ABSTRACT

Systems and methods are provided for associating confirmed user (CU) indications to network-initiated transactions. An example method includes receiving network details for a transaction between a user and a first party and storing the network details in a data repository in association with an transaction identifier for the transaction. The method also includes accessing, from the data repository, network details for multiple prior transactions between the user and the first party and comparing the network details for said transaction and the network details for the multiple prior transactions. The method then includes, based on a match between the network details for said transaction and the network details for the multiple prior transactions, appending a confirmed user flag in an authorization message for the transaction, whereby an issuer relies on the confirmed user flag in deciding to approve or decline the transaction.

### FIELD

The present disclosure generally relates to systems and methods for use in authenticating users, and in particular to systems and methods for use in authenticating users for interactions based on network details for the interactions and also historical interactions.

### BACKGROUND

This section provides background information related to the present disclosure which is not necessarily prior art.

Users are known to interact with various parties for different reasons. For example, a user may interact with a first party to purchase one or more products from the first party. In doing so, the user may rely on a payment account to fund the interaction with the first party. And, an issuer of the payment account may pay the first party, and then, later collect funds from the user to reimburse the issuer for funds paid to the first party.

### DRAWINGS

The drawings described herein are for illustrative purposes only of selected embodiments and not all possible implementations, and are not intended to limit the scope of the present disclosure:

FIG. 1 illustrates an example system for use in associating a confirmed user (CU) to network-initiated transactions, based on network details associated with the transactions;

FIG. 2 is a block diagram of an example computing device that may be used in the system of FIG. 1;

FIG. 3 illustrates an example method that may be implemented via the system of FIG. 1 for use in associating a confirmed user (CU) to a network-initiated transaction; and

FIG. 4 illustrates network details for three example transactions.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

When users fund interactions with first parties (e.g., merchants, etc.) to purchase product(s), the users often present payment cards (e.g., credit cards, debit cards, etc.) indicative of specific payment accounts to fund the interactions. More recently, first parties offer network-based platforms (e.g., website, applications, etc.) for the sale of products to users, whereby the users are not present at the first parties. In such interactions, rather than present payment cards, the users enter account numbers, or other information, from or linked to the payment accounts, whereby the interactions are initiated and the product(s) are delivered to the users (or other designated persons).

As the network-based platform interactions have increased in prevalence, fraudulent users have taken advantage thereof to dispute the interactions even when the products were in fact ordered by the users and received by the users. This is referred to as first-party fraud, which is a challenge to specific aspects to the network-based platform implementation of interactions (or transactions). Credit reporting has been proposed as a solution, but the credit reporting is problematic in connection with the technical problem of first-party fraud, as it is commonly imprecise to the specific instances of suspected first-party fraud.

Uniquely, the systems and methods herein permit for appending a confirmed user (CU) flag to an authorization request, or otherwise, in connection with network-based interactions. In particular, in one example, a host computing device receives network details for a transaction between a user and a first party, where the network details include at least a delivery data element and an identifier of a computing device involved in the transaction, and the network details associated with a transaction identifier for the transaction. The host computing device then stores the network details, in association with the transaction identifier, in a data repository. In turn, the network details for the transaction may be verified (e.g., against network details for one or more prior transactions, against identity details for the user, etc.) and, based on such verification, a confirmed user flag may be appended in an authorization request for the transaction. An issuer or other downstream system (e.g., chargeback system, etc.) may then use and/or rely on the confirmed user flag in taking one or more actions (e.g., in deciding to approve or decline the transaction, in deciding to approve for decline a chargeback request for the transaction, etc.) and/or in providing additional insights to merchants, issuers, etc. regarding the transaction, etc. In this manner, a technical solution, including a specific sequence to data processing operation, in the specific architecture (e.g., in connection with the authorization messaging, etc.), is provided to offset uncertainty associated with the transactions.

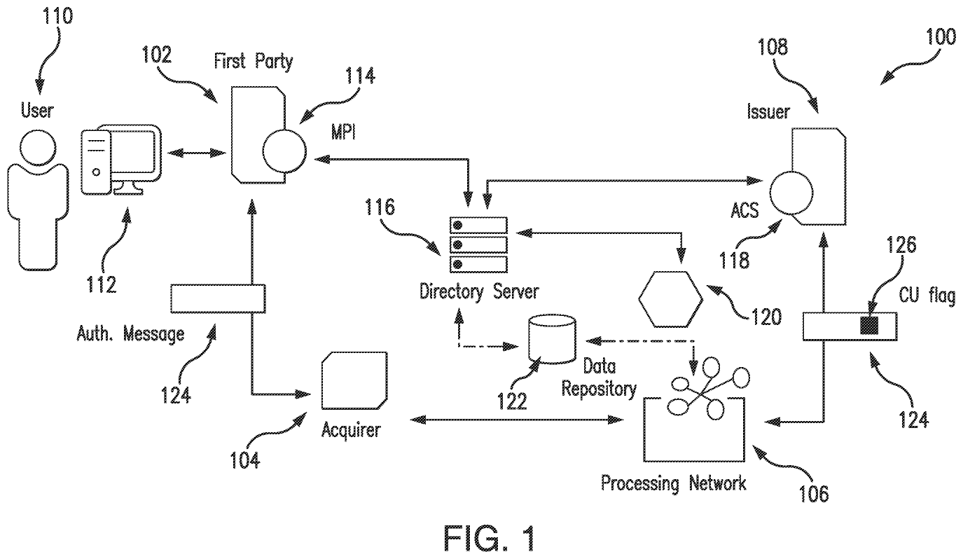

FIG. 1 illustrates an example system 100 for implementing a process that may be utilized for authenticating and verifying a consumer in connection with a transaction by the consumer, and which is consistent with the EMV® 3-D Secure™ specification, for example. It should be appreciated, however, that not all details of the EMV® 3-D Secure™ protocol (or specification) are discussed herein, since a complete detailed disclosure of such information may be readily understood by referencing the EMV® 3-D Secure™ specification and or discussions thereof. In addition, the illustrated system 100 includes a plurality of entities that interact with each other by exchanging multiple, specifically formatted messages over secure communication channels (e.g., as defined in the EMV® 3-D Secure™ protocol/specification (see, e.g., https://www.emvco.com/emv-technologies/3d-secure/), etc.).

In the illustrated embodiment, the system 100 includes a first party 102, an acquirer 104, a processing network 106 and an issuer 108, each of which is coupled in communication via one or more networks, as indicated by the arrowed lines in FIG. 1. The network(s) may include, without limitation, one or more local area networks (LANs), wide area networks (WANs) (e.g., the Internet, etc.), mobile networks, virtual networks, other networks as described herein, and/or other suitable public and/or private networks capable of supporting communication among two or more of the illustrated parts, or even combinations thereof.

The first party 102, in this example embodiment, is a merchant, which is configured to offer for sale and to sell products to consumers including, for example, a user 110. The first party 102 may be disposed and/or accessible at one or more physical locations, such as, for example, at one or more brick-and-mortar locations, etc. In this example embodiment, the first party 102 is associated with one or more virtual locations, for example, via one or more applications, websites, etc. The virtual location(s) may include any application, channel or platform, which permits the user 110 or other users to interact with the first party 102, while apart from or separate from the first party 102 (or any of the brick-and-mortar locations thereof) (e.g., a website, etc.).

The acquirer 104 and the issuer 108 are both financial institutions, such as, for example, banks, etc., which issue accounts. In this example embodiment, the acquirer 104 is configured to issue an account to the first party 102, and the issuer 108 is configured to issue an account to the user 110. In particular, the issuer 108 is configured to issue a payment account, such as, for example, a credit account, debit account, prepaid account, etc., to the user 110, which may be used to fund purchases, etc. The payment account issued to the user 110 is associated with a primary account number or PAN (and also an expiration date, verification code, or other identifying information for the account, etc.). The issuer 108 may also be configured to issue a payment card to the user 110, which includes the above information about the payment account.

The user 110 is associated with a computing device 112, which is configured to access the one or more virtual merchant locations of the first party 102. The computing device 112 may be a mobile (or portable) device, such as, a smartphone, tablet, laptop, etc., or it may be a desktop computer, server, etc.

Based on the above, the user 110 may access a virtual location of the first party 102, via the computing device 112, and purchase one or more products. The purchase transaction may be funded by the payment account issued by the issuer 108, whereby funds are transferred (or directed) by the issuer 108 to the account of the first party 102 at the acquirer 104. The processing network 106 is configured to coordinate the messaging associated with authorization of the transaction, and then, later, clearing and settlement of the transaction, depending on the specific type of transaction, etc. In one embodiment, the authorization message may be embodied in messages consistent with the ISO 8583 standard, or alternatively, the ISO 20022 standard, etc.

In addition to the above, as indicated, the system 100 is configured for enhanced authentication, which may be consistent with the EMV® 3-D Secure™ specification. As such, in this example embodiment, the system 100 includes a merchant plug-in (MPI) 114, which is integrated, in whole or in part, at the first party 102. The MPI 114 is configured to coordinate messaging, for authentication, advice, or other communication available in the respective specification, with a directory server 116. The directory server 116 is associated with and/or integrated into the processing network 106. The directory server 116 is configured to coordinate the messaging from the MPI 114 to an access control server (ACS) 118, which is associated with or integrated with, in whole or in part, the issuer 108. In this way, the user 110 may be authenticated as part of performing the transaction.

In addition, in connection with the transaction herein, the system 100 includes a decision management host 120, which is configured to generate a confirmed user (CU) flag (as a form of identity check) for the transaction, based on certain criteria, as explained below, and to cooperate with the processing network 106 to include the CU flag as part of authorization and/or to cooperate with the issuer 108 (or the processing network 106) to serve up the CU flag (or data upon which the CU flag is based) in connection with a post-transaction communication.

While the host 120 is illustrated as a single part of the system 100 in FIG. 1, it should be appreciated that the host 120 may be a combination of more than one or more different parts associated with, or not, the processing network 106, the issuer 108, etc. In this example embodiment, the host 110 and/or the directory server 116 may further be included and/or integrated, in whole or in part, in the processing network 106.

With regard to the CU flag, in particular, for the transaction (or interaction) between the user 110 and the first party 102, at the virtual location, the first party 102 is configured to initiate the transaction, to the user 110, for payment in an amount of the purchase. In connection therewith, in this example embodiment, the first party 102 is configured to submit network details for the transaction to the directory server 116, via the MPI 114 (e.g., prior to authorization of the transaction, as part of authenticating the user 110, etc.). In doing so, the first party 102 may share the network details as a data only (non 3-D Secure) message, or the first party 102 may use a 3-D Secure payment authentication message (e.g., of appropriate type, etc.) to share the details. In either case, the network details may include account details for the user 110 (e.g., personal identifying information (PII) for the user 110, etc.) such as, for instance, a telephone number (e.g., a home telephone number, a cellular telephone number, a work telephone number, etc.), an email address of the user 110, an IP address of the computing device 112 or other device identifier (e.g., electronic serial number (ESN), etc.) for the device 112 (or for another device involved in the transaction), a transaction identifier (ID), a time/date of the transaction, locations, product details, and other data indicative of the occurrence of the transaction, etc. It should be appreciated that the network details may further include payment account numbers, expiration dates, tokens, amounts, names, mailing/delivery addresses, etc.

In one specific example, the network details are predefined, whereby the first party 102 (or the MPI 114) is configured to submit identity elements, delivery data elements (e.g., a data element indicative of or associated with delivery (e.g., a shipping address, an email address, a computing device name, etc.), etc.), and additional identity factors, concatenated consistent with a length and format permitted by the specification (e.g., EMV® 3-D Secure™ specification, etc.). For example, the format and content of the network details may be an IP address, an email address (e.g., for delivery of a virtual product (e.g., streaming, network rentals, etc.), etc.), and a telephone number, concatenated as xxx.xxx.xxx.xxx;name@domain.com;xxx-xxx-xxxx, where each follows a specific format. This may define a standard sharing of network digital data across various different accounts and first parties, and also issuers, etc.

As indicated above, it should be appreciated, again, that the network details may be communicated to the directory server 116, via the MPI 114, as part of an authentication request, or other message, such as, for example, an advise request or other messaging type within the applicable specification. That said, it should be appreciated that the network details may be communicated to the directory server 116, or the host 120 (or data repository 122), via a different channel (e.g., an application programming interface (API) exposed by the host 120, etc.), or even through an authorization message, describe below, in other examples.

In response, the directory server 116 is configured to store the network details in the data repository 122 and/or communicate the network details to the host 120, which in turn, is configured to store the network details in the data repository 122. Further, the directory server 116 may be configured to acknowledge the network details and/or to further participate in the authentication directly or though the ACS 118.

Based on the network details, either received from the directory server 116 (or otherwise) and/or accessed in the data repository 122, the host 120 is configured to determine a score for the specific transaction, which is based on one or more rules associated with the network details and historical network details for the user's payment account, computing device 112, and/or the user 110 herself/himself, etc. included in the data repository 122.

In this example embodiment, the host 112 is configured to identify prior transactions for the same payment account and the same first party 102, within or outside an interval, which were not disputed or were “good” transactions (e.g., were not associated with fraudulent activity and/or chargebacks previously, etc.). For example, the host 120 may identify transaction, which are more than fifteen, thirty, or one hundred twenty days old, etc. For the transactions, the host 120 is configured to access an IP address, a device name identifier (e.g., ESN, etc.), etc., of the computing device used to initiate the transactions, as well as a shipping address, an email address, a billing address, a user name, a phone number, a product description, or other suitable data (which is available for the present transaction) for the transactions, etc. (all broadly network details). After accessing the data, the host 120 is configured to compare, for example, the IP address from the prior “good” transactions to the IP address of the computing device 112, and to also compare the email address of the prior “good” transactions to the email address included in the network details for the present transaction. It should be appreciated that the other network details may be compared alone, or in combination, based on available data, rules, etc.

In this example, when the IP addresses match, and the email addresses (or shipping addresses, etc.) match, the host 120 is further configured to match an additional proof of identity, such as, for example, an account ID/user ID, a telephone number, a device name, a billing address, a cardholder name, a device location, or other suitable data, etc. When the additional proof of identity is a match, the host 102 is configured to define confidence in the transaction as being proper (e.g., the transaction is identified as a generally low risk transaction, etc.). The host 120 is configured to then set a CU flag for the transaction and store the same, for example, in the data repository 122 in association with the network details for the transaction (such that the transaction and corresponding CU flag may be subsequently identified (e.g., by the processing network 106, etc.) based on the network details for the transaction (e.g., the transaction ID, etc.), etc.).

Optionally, it should be understood, in setting the CU flag, that the number of identity data elements accessed by the host 120 may be based on the transaction (e.g., more elements for higher amounts, etc.).

In the meantime, the first party 102 is configured to compile and transmit an authorization message 124 to the acquirer 104. The authorization message 124 includes an account number, an amount, identifiers associated with the first party 102, a transaction identifier, etc., which is consistent with ISO 8583 standard or other suitable standard. The acquirer 104 is configured, in turn, to pass the authorization message 124 to the processing network 106. The processing network 106 is configured to detect the authorization message 124, for example, based on the transaction ID or other network detail(s) therefor (e.g., as corresponding to a transaction for which the host 120 has performed an evaluation, etc.) and to append CU flag 126 to the authorization message 124. The CU flag 126 may include a value indicative of a confidence, or alternatively, a YES or NO, or 0 or 1 indicative of the qualification of the transaction for confirmed user status. The CU flag 126 may be included, for example, in data element (DE) 48 sub-element (SE) 56 of the authorization message 124 (or in another DE and/or SE as appropriate or desired, etc.).

The processing network 106 is configured to then pass the authorization message 124 to the issuer 108.

The issuer 108, in turn, is configured to authorize, or decline the transaction, based, in part, on the CU flag 126 being present or not present in the authorization message 124. Based thereon, the issuer 108 is configured to compile and transmit an authorization reply back to the first party 102, through the processing network 106 and the acquirer 104. In addition, the issuer 108 may be configured to designate the transaction as associated with “enhanced security” or other descriptor, which is viewable by the user 110 when viewing the transaction on the mobile application and/or website associated with the issuer 108. In this manner, the designator may be associated with the transaction at the point of claiming a dispute, which may deter certain users from falsely seeking a chargeback.

It should be appreciated that, alternatively, the network details may be collected by the host 120 (as part of the authorization process or otherwise), and where the CU flag 126 is omitted from the authorization message, in other system embodiments.

Thereafter, the issuer 108 may receive a dispute for the transaction, from the user 110, after the transaction is completed, or at least authorized. In connection therewith, the issuer 108 is configured to submit a confirmed user (CU) request to the host 120 (e.g., via an email, via an electronic message, via an API call to an API exposed by the host 120, or other suitable channel of communication, etc.). In response, the host 120 may be configured to access the CU flag (when previously set), based on the transaction identifier, or to access the network details based on the transaction identifier and assess the CU flag, as described above. The host 120 is further configured, then, to return the CU flag and/or to network details for the transaction to the issuer 108.

With the network details, the issuer 108 may be configured to respond to the dispute from the user 110 with relevant data about the transaction, the computing device 112 used in the transaction (or for receipt of the products), etc., as the data relates to similar data for prior transactions or data associated with the present dispute (i.e., whether the computing device 112 was used to initiate the dispute of the transaction), etc.

In some examples, where the CU flag is defined for the transaction, upon completion of the transaction (or before), the issuer 108 may identify the transaction as being a verified transaction (e.g., associate a banner, icon, etc. with the transaction in a statement or listing of transactions associated with the user's account (e.g., through a web-access interface to the account, etc.); etc.). In this way, the user 110 may be made aware of the verification for the transaction, whereby fraudulent challenges to the transaction by the user 110 may be deterred (based on the associated banner, icon, etc., as such verified transactions may be more difficult to dispute, etc.).

While in the example above, the network details of the current transaction are compared to network details of one or more prior transactions, it should be appreciated that in other examples, the network details of the current transaction may be compared to data for the user 110 included in one or more other repositories, which may be associated with prior transactions or not. For instance, the host 120 may be included in and/or associated with an identity provider and/or a repository of identifying information for the user 110. In such an example, the host 120 may be configured to then retrieve data for the user 110 from the identity provider and/or repository, for example, based on a payment account credential used in the transaction (e.g., primary account number (PAN), phone number, email address, etc.), etc., and to compare the retrieved data against the network details for the current transaction. In this way, a match may be found between the network details of the current transaction and the retrieved data, as a basis for defining the CU flag, potentially apart from historical transactions.

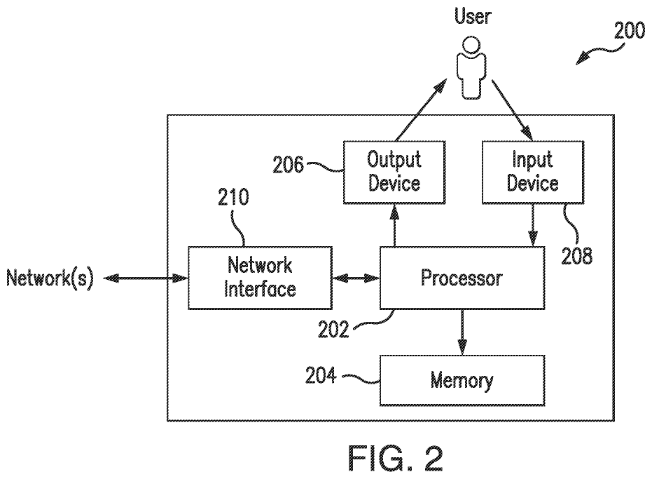

FIG. 2 illustrates example computing device 200, which may include, for example, one or more servers, workstations, personal computers, laptops, tablets, smartphones, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In at least one embodiment, the computing device 200 is accessed (for use as described herein) as a cloud, fog and/or mist type computing device. It should be understood that the first party 102 (including the MPI 114), acquirer 104, the processing network 106, the issuer 108 (and the ACS 118), the computing device 112, the directory server 116, the host 120 and the data repository 122 may be consider consistent with and/or integrated in a computing device similar to or the same as the computing device 200. With that said, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permits data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, IAVs, AAVs, authentication requests, keys, MACs, DSRP cryptograms, tokens, account numbers (e.g., PANs, etc.), and/or other types of data (and/or data structures) suitable for use as described herein. Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 and/or other computer system components configured to perform one or more of the various operations herein, whereby in performing the operations the computing device 200 may be transformed into a special-purpose computing device. It should be appreciated that the memory 204 may include a variety of different memories, each implemented in one or more of the functions or processes described herein.

In the example embodiment, the computing device 200 also includes an output device 206 that is coupled to (and that is in communication with) the processor 202. The output device 206 outputs information, such as flags, network details, designators for transactions, etc., visually, for example, to the user 110, or user associated with the issuer 108 (e.g., a disputes manager, etc.), or other information to other users associated with any of the entities illustrated in FIG. 1, at a respective computing device, etc. The output device 206 may include, without limitation, a liquid crystal display (LCD), a light-emitting diode (LED) display, an organic LED (OLED) display, an “electronic ink” display, speakers, etc. In some embodiments, the output device 206 may include multiple devices.

In addition, the computing device 200 includes an input device 208 that receives inputs from the user (i.e., user inputs) such as, for example, entries of payment account numbers or other details, etc., from the user 110, etc. The input device 208 may include a single input device or multiple input devices. The input device 208 is coupled to (and is in communication with) the processor 202 and may include, for example, one or more of a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device, may behave as both the output device 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks and/or one or more other computing devices herein.

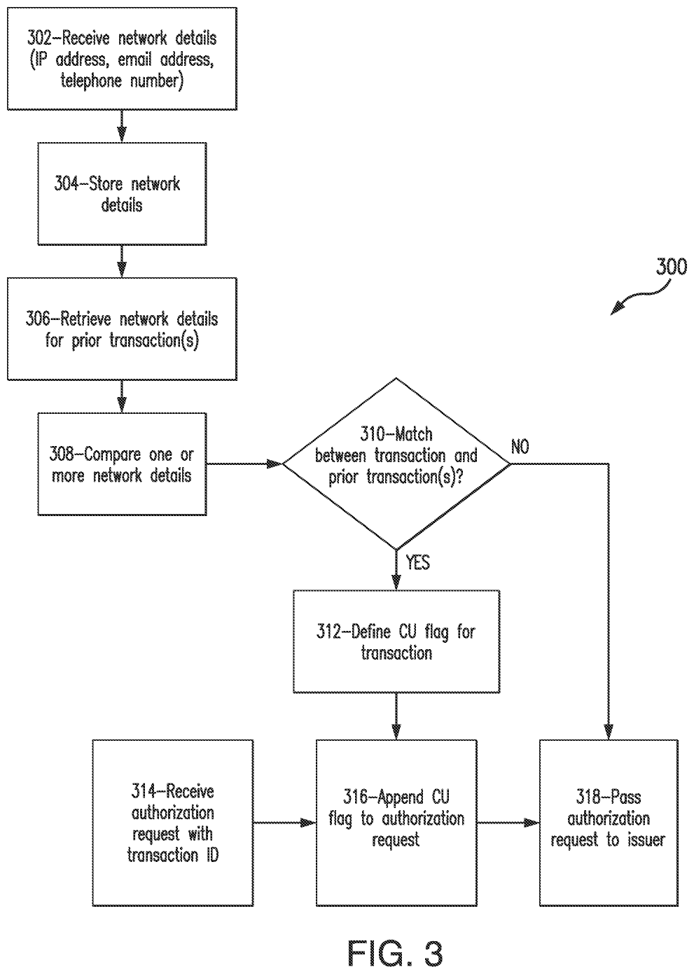

FIG. 3 illustrates an example method 300 for associating a confirmed user (CU) to network-initiated transactions. The example method 300 is described (with reference to FIG. 1) as generally implemented in the host 120 of the system 100, and with further reference to the computing device 200. As should be appreciated, however, the methods herein should not be understood to be limited to the example system 100 or the example computing device 200, and the systems and the computing devices herein should not be understood to be limited to the example method 300.

In the illustrated method 300, for a transaction initiated by the user 110 at the computing device 112 with the first party 102, the decision management host 120 receives, at 302, network details from the MPI 114 for the transaction (e.g., via the directory server 116, etc.) (or through an API call or otherwise) (broadly, from the first party 102) (e.g., as part of authenticating the user 110 and prior to authorizing the transaction, etc.). The network details, in this example, include the IP address of the computing device 112 (at which the transaction is initiated), along with the delivery data element and the telephone number associated with the transaction (as provided by the user 110 to the first party 102, for example). In this example, the delivery data element includes an email address associated with the delivery of a virtual product (e.g., streaming service, network movie rental, music rental, etc.). In addition, the network details include, or are associated with, a transaction identifier for the transaction, the account number of the payment account designated to fund the transaction, and also an identifier of the first party 102.

It should be appreciated that more or less network details, such as described above, may also be provided to the decision management host 120. For example, the telephone number may be omitted in favor of a location of the computing device 112 (at the time of the transaction), or a billing address, or other suitable identifying information for either the computing device 112 or the user 110.

Upon receipt of the network details, the decision management host 120 stores, at 304, the network details in the data repository 122 for the transaction. In connection therewith, in this example, the decision management host 120 also accesses or retrieves, at 306, network details for one or more prior transactions (generally to the same account, but potentially to one or more different associated accounts, etc.). In particular, the decision management host 120 accesses prior transactions directed to the same account (e.g., based on searching of the account number of the account designated to fund the transaction, etc.) and to the same first party 102 (e.g., based on searching the identifier of the first party 102, etc.) included in, or with, the network details, etc. Additionally, the decision management host 120 accesses only those prior transactions, which are consistent with a defined interval. For example, the decision management host 120 may access only those transactions which are older than the defined interval (e.g., the transaction date for transactions beyond 120 days from a current day, etc.). Moreover, the decision management host 120 only accesses those prior transaction, which were not disputed.

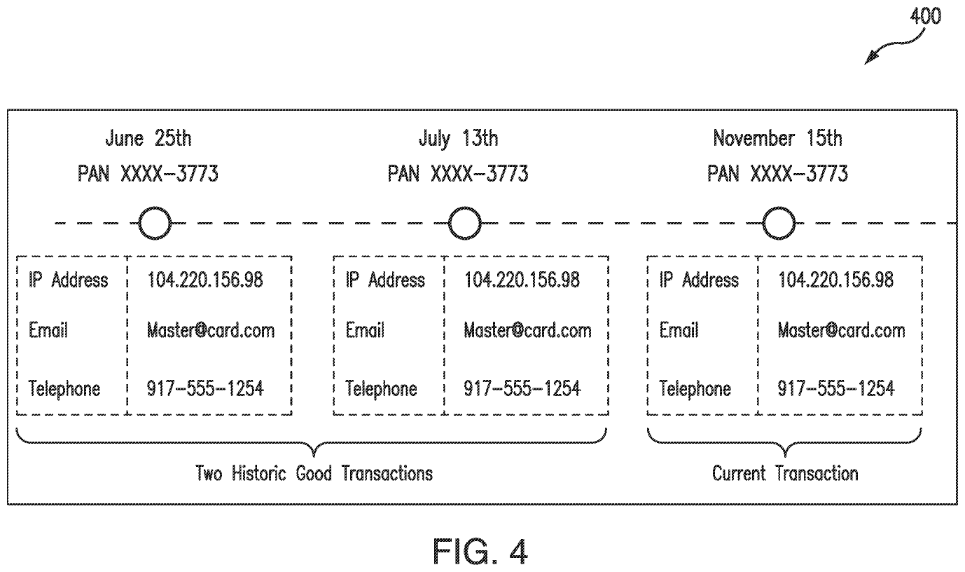

FIG. 4 illustrates a block diagram of the current transaction, along with two prior, historical transactions, which were not disputed. As shown, each of the three transactions in FIG. 4 were funded (or designated to be funded) by the same account (as indicated by the account number PAN XXXX-3773), and each of the three transaction involved the same first party 102. As shown, the prior transactions are from June 25th and July 13th, and the present transaction is dated November 15^{th}, whereby the prior transactions accessed by the decision management host 120 are more than 120 days (broadly, defined interval) old. The network details, mainly, the IP address, the email address, and the telephone number, are also included for each of the three transactions.

It should be appreciated that more or less prior transactions may be retrieved in other examples. And, it should also be appreciated that other network details may be included in other example transactions.

With reference again to FIG. 3, at 308, the decision management host 120 compares the network details of the transaction to the prior transactions (e.g., to one or more of the prior transactions to the same account as the current transaction (or to one or more different accounts), etc.). In this example, the decision management host 120 compares the IP address for the three transactions (as shown in FIG. 4, for the prior transactions and the current transaction), the email addresses for the three transactions, and the telephone numbers for the three transactions. The decision management host 120 then determines, at 310, whether there is a match. It should be appreciated that the decision management host 102 may compare network details for the current transaction to multiple different prior transactions, or it may compare the network details for the current transaction to one prior transaction. In connection with such comparison, one or more rules may be applied to the number of required matching (or non-matching) prior transactions in order to establish (or not establish) the CU flag. For example, in some embodiments, network details of the current transaction must match network details of at least two prior “good” transactions in order to establish the CU flag. In other embodiments, the network details of the current transaction must match network details of more than two prior “good” transactions in order to establish the CU flag (e.g., five transactions, etc.). In some embodiments, the host 120 may not establish the CU flag if the network details of the current transaction fail to match at least one prior “good” transaction, or if the network details of the current transaction match the network details of at least one prior “bad” transaction (e.g., at least one prior transaction identified as a fraudulent transaction, or subject to a successful chargeback, etc.).

While in the example above, the network details of the current transaction are again compared to the network details of the prior transactions, it should be appreciated that the network details of the current transaction may be compared to data for the user 110 included in one or more other repositories in other examples. For instance, the host 120 may be associated with an identity provider and/or a repository of identifying information for the user 110. As such, the host 120 may then retrieve data for the user 110 from the identity provider and/or repository, for example, based on a payment account credential, or phone number, or email address, etc., used in the transaction, etc., and compare the retrieved data against the network details for the current transaction. In this way, a match may be found between the network details of the current transaction and the retrieved data, as a basis for defining the CU flag, but potentially, apart from one or more historical transactions for the user 110 to the account.

In any case, when there is no match between the network details of the current transaction and other know, available data for the user 110, the decision management host 120 does not define or append a CU flag for the transaction. In such instances, the transaction proceeds in a conventional manner from the first party 102 to the issuer 108, with the authorization request passing to the issuer 108 for approval (or decline) of the transaction. And, any subsequent dispute involving the transaction would following normal or typical dispute/chargeback processing (since the CU flag was not defined for the transaction), for example, subject to the user 110 and/or issuer 108 attesting to the fact that the user's account was used in an unauthorized manner and the user 110 was not involved in or did not participate in the transaction, etc.

Conversely, when there is a match, the decision management host 120 defines, at 312, a CU flag for the transaction. As shown in FIG. 4, the network details match across the transactions, whereby a CU flag is defined or set for the current transaction. The CU flag may be stored, by the decision management host 120, with the network details for the transaction in the data repository 112. In connection therewith, when the CU flag is defined, any dispute regarding the transaction by the user 110, for example, may be recognized as potentially indicative of first party-fraud (e.g., whereby additional proof may be required by the issuer 108 from the user 110 to establish that the user's account was used in an unauthorized manner and/or that the user 110 was not involved in or did not participate in the transaction, etc.).

In some examples, the current transaction and the one or more prior good transactions may include network details that only partially match. For instance, a user may have different IP addresses across two groups of the prior good transactions, as the user may sometimes shop at home using his/her Wi-Fi (having a first IP address) and other times shop on the go using his/her mobile device (having a second IP address). Here, network details of the current transaction may be specifically compared to prior good transactions having the same IP address as the current transaction to determine if the remaining network details match (e.g., whereby the first party 102 may have input or ability to select prior good transactions to match users' identity and transaction activity, etc.). And, as above, where the remaining network details match, the decision management host 120 defines a CU flag for the transaction (otherwise, no CU flag is defined).

Subsequently, the processing network 106 detects, at 314, an authorization message (e.g., an authorization request, etc.) from the first party 102, via the acquirer 104, based on the transaction identifier included therein (e.g., based on the transaction identifier for the transaction matching a transaction identifier stored in the data repository 122 and associated with a CU flag, etc.). Based on the detection, the processing network 106 appends, at 316, the CU flag to the authorization message. The CU flag may be appended at a specific data element, which is predefined to include the CU flag between the issuer 108 and the processing network 106. At 318, the processing network 106 passes the authorization message (with the CU flag) to the issuer 108, whereupon the issuer decides to approve or decline the transaction, based, potentially, at least in part, on the CU flag included therein.

In view of the above, the systems and methods herein provide confirmed user indications associated with network initiated transactions.

Again, and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving network details for a transaction between a user and a first party, the network details including at least a delivery data element and an identifier of a computing device involved in the transaction, and the network details associated with a transaction identifier for the transaction; (b) storing the network details, in association with the transaction identifier, in a data repository; (c) accessing, from the data repository, network details for multiple prior transactions between the user and the first party; (d) comparing the network details for said transaction and the network details for the multiple prior transactions; (c) based on a match between the network details for said transaction and the network details for the multiple prior transactions, appending a confirmed user flag in an authorization message for the transaction, whereby an issuer relies on the confirmed user flag in deciding to approve or decline the transaction; (f) receiving an account number for an account designated to fund the transaction and an identifier of the first party; (g) receiving the authorization message from an acquirer associated with the first party; and/or (h) transmitting the authorization message, with the confirmed user flag, to the issuer.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising.” “including.” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on.” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112 (f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in associating a confirmed user (CU) to network-initiated transactions, the method comprising:
receiving, by a host computing device, network details for a transaction between a user and a first party, the network details including at least a delivery data element and an identifier of a computing device involved in the transaction, and the network details associated with a transaction identifier for the transaction;
storing, by the host computing device, the network details, in association with the transaction identifier, in a data repository;
accessing, by the host computing device, from the data repository, network details for multiple prior transactions between the user and the first party;
comparing the network details for said transaction and the network details for the multiple prior transactions; and
based on a match between the network details for said transaction and the network details for the multiple prior transactions, appending a confirmed user flag in an authorization message for the transaction, whereby an issuer relies on the confirmed user flag in deciding to approve or decline the transaction.

2. The computer-implemented method of claim 1, wherein the identifier of the computing device includes an IP address of the computing device;
wherein the delivery data element includes an email address; and
wherein the network details further include a telephone number.

3. The computer-implemented method of claim 1, wherein the network details further include one or more of: a shipping address, a billing address, an account ID/user ID associated with the first party, a cardholder name associated with an account designated to fund the transaction, a device location of the computing device, and a product description.

4. The computer-implemented method of claim 1, further comprising receiving an account number for an account designated to fund the transaction and an identifier of the first party; and
wherein accessing the multiple prior transactions includes searching for the multiple prior transactions based on the account number and the identifier associated with the first party.

5. The computer-implemented method of claim 4, wherein accessing the multiple prior transactions includes accessing the multiple transactions based on a defined interval, whereby the multiple prior transactions are older than the defined interval.

6. The computer-implemented method of claim 1, wherein the issuer is an issuer of an account designated to fund the transaction.

7. The computer-implemented method of claim 1, further comprising:
receiving the authorization message from an acquirer associated with the first party; and
transmitting the authorization message, with the confirmed user flag, to the issuer.

8. A non-transitory computer-readable storage medium comprising executable instructions, which when executed by at least one processor, cause the at least one processor to:
receive network details for a transaction between a user and a first party, the network details including at least a delivery data element and an identifier of a computing device involved in the transaction, and the network details associated with a transaction identifier for the transaction;
store the network details, in association with the transaction identifier, in a data repository;
compare the network details for said transaction and network details for the user; and
based on a match between the network details for said transaction and the network details for the user, appending a confirmed user flag in an authorization message for the transaction.

9. The non-transitory computer-readable storage medium of claim 8, wherein the identifier of the computing device includes an IP address of the computing device;
wherein the delivery data element includes an email address; and
wherein the network details for the transaction and the network details for the user include a telephone number.

10. The non-transitory computer-readable storage medium of claim 8, wherein the network details for the transaction and the network details for the user include one or more of: an address, a name, and a device location of the computing device.

11. The non-transitory computer-readable storage medium of claim 8, wherein the executable instructions, when executed by the at least one processor, further cause the at least one processor to:
receive an account number for an account designated to fund the transaction and an identifier of the first party; and
access network details for multiple prior transactions between the user and the first party based on the account number and the identifier associated with the first party.

12. The non-transitory computer-readable storage medium of claim 11, wherein the executable instructions, when executed by the at least one processor to compare the network details for said transaction and one or more network details for the user, cause the at least one processor to compare the network details for said transaction and the network details for the multiple prior transactions.

13. The non-transitory computer-readable storage medium of claim 8, wherein the executable instructions, when executed by the at least one processor, further cause the at least one processor to:
receive the authorization message from an acquirer associated with the first party; and
transmit the authorization message, with the confirmed user flag, to the issuer.

14. A system for use in associating a confirmed user (CU) to network-initiated transactions, the system comprising a host computing device configured to:
receive network details for a transaction between a user and a first party, the network details including at least a delivery data element and an identifier of a user computing device involved in the transaction, and the network details associated with a transaction identifier for the transaction;
store the network details, in association with the transaction identifier, in a data repository;
compare the network details for said transaction and network details for the user; and
based on a match between the network details for said transaction and the network details for the user, appending a confirmed user flag in an authorization message for the transaction.

15. The system of claim 14, wherein the identifier of the user computing device includes an IP address of the user computing device;
wherein the delivery data element includes an email address; and
wherein the network details for the transaction and the network details for the user include a telephone number.

16. The system of claim 14, wherein the network details for the transaction and the network details for the user include one or more of: an address, a name, and a device location of the user computing device.

17. The system of claim 14, wherein the host computing device is further configured to:
receive an account number for an account designated to fund the transaction and an identifier of the first party; and
access network details for multiple prior transactions between the user and the first party based on the account number and the identifier associated with the first party.

18. The system of claim 17, wherein the host computing device is configured, in order to compare the network details for said transaction and one or more network details for the user, to compare the network details for said transaction and the network details for the multiple prior transactions.

19. The system of claim 14, wherein the host computing device is further configured to:
receive the authorization message from an acquirer associated with the first party; and
transmit the authorization message, with the confirmed user flag, to the issuer.
